(19) United States
(12) Patent Application Publication
(10) Pub. No.: US 2003/0174356 A1
(43) Pub. Date: Sep. 18, 2003

(54) Tracking printing in a network

(76) Inventors: Darrel Cherry, Boise, ID (US); James Clough, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/098,802

(22) Filed: Mar. 15, 2002

(51) Int. Cl. G06F 15/00; B41J 1/00

(52) U.S. Cl. 358/1.15; 358/1.18

(57) ABSTRACT

Various systems, methods, and programs embodied in computer readable mediums are provided for tracking printing on a number of printers for accounting purposes. In one embodiment, a method is provided that includes the steps of determining an origination location of a print job, determining a destination printer location associated with the print job, determining a number of printed pages associated with the print job, determining a print charge to be accessed for printing the print job, and, determining a location to which the print charge is to be accessed.

### BACKGROUND OF THE INVENTION

The business office of the present day is becoming more and more mobile. For example, hotels and other similar venues now offer rooms with access to the Internet and other networks. In some cases, various hotels have offered in-room printing facilities. These existing printing facilities typically require a user to pre-register with the hotel in order to gain access thereto. Also, such printing systems require a user to install special software on their laptop, personal digital assistant, or other mobile computing system that provides for user authentication when interfacing with the network of a specific hotel. Often, a user is further required to provide payment information such as a credit card number, etc. All of these requirements can be viewed by users as hurdles that ultimately dissuade them from using the printing facilities.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a network that provides for printing in a number of different locations;

FIG. 2 is a block diagram of one embodiment of a print server employed in the network of FIG. 1;

FIG. 3 is a flow chart of a first embodiment of a print tracking system executed, for example, in a print server in the network of FIG. 1;

FIG. 4 is a flow chart of a second embodiment of a print tracking system executed, for example, in a print server in the network of FIG. 1;

FIG. 5 is a flow chart of a third embodiment of a print tracking system executed, for example, in a print server in the network of FIG. 1; and

FIG. 6 is a flow chart of a print charge calculator executed as a portion of any one of the print tracking systems of FIGS. 3, 4, or 5.

### DETAILED DESCRIPTION OF THE INVENTION

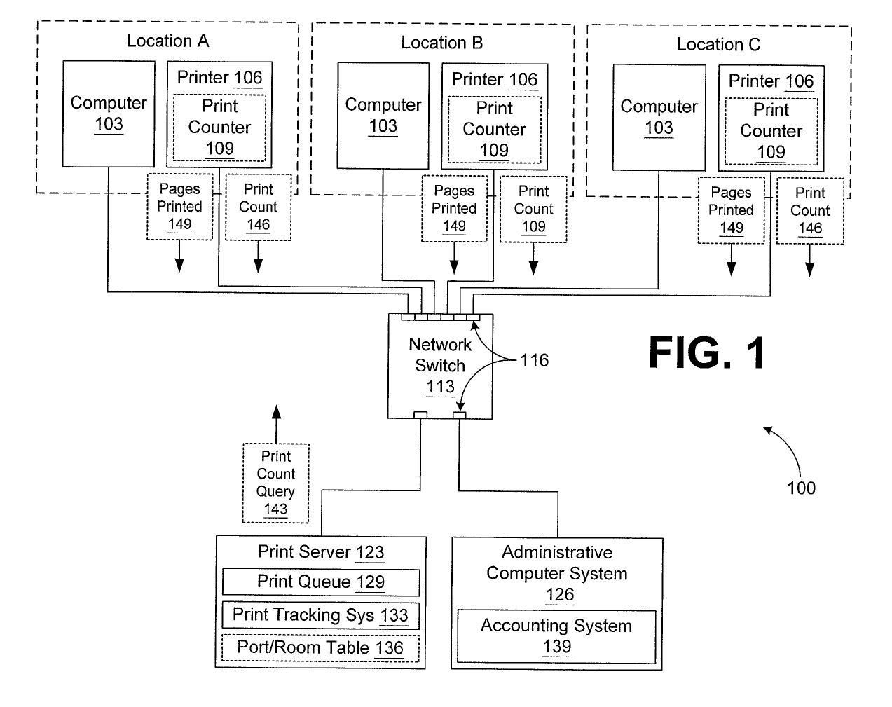

With reference to FIG. 1, shown is a local area network 100 that provides for billing of printed pages on various printers included therein according to an embodiment of the present invention. The local area network 100 includes a number of computers 103 that are located in locations A, B, and C as shown. Each of the computers 103 may be, for example, a general purpose computer system, a personal digital assistant, a lap top, or other device with like capability. The locations A, B, and C may be, for example different rooms within a building such as, for example, a hotel or other facility. Although a local area network 100 is shown, it is understood that the various embodiments of the present invention may be implemented in a wide area network, wireless network, the Internet, a combination of two or more of the foregoing networks, or other network arrangement.

The local area network 100 also includes a number of networked printers 106. One or more of the printers 106 are located in locations A, B, and C. Each of the printers 106 may include, for example, a print counter 109 that provides a number of printed pages per a specific print job as will be discussed. The print counter 109 may provide different values for monochrome prints, color prints, dense color prints, fax prints, copier prints, etc. There may be many more computers 103 and printers 106 included within the local network 100 beyond those shown, wherein the computer 103 and printers 106 shown in locations A, B, and C are shown as examples. Each of the printers 106 may be, for example, an ink jet printer, laser printer, or other type of printer. Also, each of the printers 106 may be an all-in-one device that provides for fax, scan, copy, and print capability. Also, each of the printers 106 may be monochrome or color.

The local area network 100 also includes one or more network switches 113. Such network switches 113 may be employed in a star configuration or other configuration as is generally known by those with ordinary skill in the art. In this respect, the network switch 113 shown in FIG. 1 as representative of what may be a multitude of network switches 113 that are interconnected in a complex local area network 100 as can be appreciated by those with ordinary skill in the art. The network switch 113 includes a number of ports 116. Each port may be linked to a wall jack through which a device may be connected to the local area network 100.

The local area network 100 also includes a print server 123 and an administrative computer system 126, both of which are coupled with the network switch 113 through appropriate ports 116. The print server 123 includes one or more queues 129, a print tracking system 133, and a port/room table 136. The administrative computer system 126 includes an accounting system 139. The print server 123 can also be connected to the local area network 100 in other topologies such as being coupled to the local area network 100 through the administrative computer system 126 or other arrangement rather than being directly coupled to one of the ports 116.

To promote a clear understanding of the various embodiments of the present invention, the following discussion described within the context of an exemplary implementation according to a specific scenario. In this exemplary scenario, it may be assumed that the local area network 100 exists within a hotel with several rooms that are rented to customers of the hotel. In this scenario, the locations A, B, and C represent rooms in the hotel and are referred to hereafter as rooms A, B, or C, although it is understood that locations A, B, and C may not be limited to rooms as such. To provide incentive for customers to stay in the hotel, the hotel includes a printer 106 within each room for guests to use. Each room includes a network port that a customer may use to plug in computer 103 such as a laptop, personal digital assistant, or other like device to access services available through the local area network 100 such as Internet access or other services, etc. Thus, a customer can plug in their computer 103 and print a document on the printer 106 located in their room (i.e. in one of rooms A, B, or C). Alternatively, the customer may print a document on another printer located in the hotel lobby, at the check-in desk, or elsewhere where the user is provided with the needed permissions.

To charge the guests for the printing of documents, the hotel needs to know from where on the network 100 a print job originated and/or which printer 106 was used to print the document. Ultimately, the goal would be to associate an account designation such as a customer's room number with a particular print job. In the present scenario, a customer's room number is employed given that most charges to a customer in a hotel are tracked with their room number, although some other account designation may be employed.

Assuming that a user wishes to employ the print services available in one of the rooms A, B, or C, then the user may create a print job with a respective computer 103 choose to print at a printer 106 in the corresponding room A, B, or C. To accomplish this, the print job is transmitted from the computer 103 and placed in a print queue 129 associated with the respective printer 106 to which the user wishes to print the desired document. Ultimately, the print queue 129 applies the print job to the respective printer 106 for printing. The hotel or other proprietor that provides for the print services may wish to generate a bill for such services. As was previously stated, the bill for a particular user's stay is usually tracked according to the hotel room or room number for that particular individual.

In order to provide for charges for use of print facilities in particular location by a particular user, various embodiments the print tracking system 133 are provided. For example, where a print job originates from a computer 103 in room A and prints on a printer 106 at room A, then the individual that is staying within room A should be charged accordingly. In one embodiment, the print tracking system 133 provides for tracking of how many pages were printed on a respective printer 106 in a specific room A, B or C. In alternative embodiments, the print tracking system 133 may determine the room A, B or C where a print job was generated as well as the room A, B, or C in which the destination printer 106 is located. Also, various embodiments of the print tracking system 133 also provide for determining how many pages are printed for a specific print job.

Once one of the various embodiments of the print tracking system 133 determines the information necessary to associate usage of print services with an account designation such as a room number, then the information is provided to the accounting system 139 that will include appropriate charges on a bill generated for the particular individual. In determining the particular information needed to charge an individual for print services, the print tracing system 133 may generate a print count query 143 at appropriate times that is applied to a respective one of the printers 106 to obtain a total count of the number of pages that have been printed by the respective printer 106 given that the printers 106 usually maintain such a figure.

The printers 106 respond to a print count query 143 with a print count 146 that indicates a total number of pages the printer 106 has printed. In addition, under certain circumstances, the printer 106 may include the print counter 109 which may track the number of pages printed for a respective print job. In such case, the print counter 109 may communicate the number of pages printed 149 in a message that is transmitted to the print tracking system 133 after printing a print job as will be discussed.

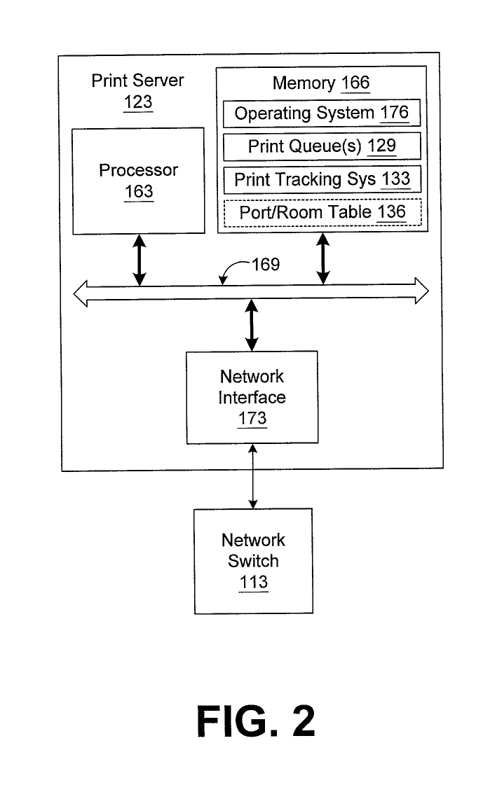

Turning then to FIG. 2 shown is a block diagram of the print server 123 according to one embodiment of the present invention. The print server 123 includes a processor circuit having a processor 163 and memory 166, both of which are coupled to a local interface 169. The local interface 169 may be, for example, a data bus with an accompanying control/address bus as can be appreciated by those with ordinary skill in the art. In this respect, the print server 123 may be, for example, a computer system, server, or other device with like capability.

The print server 123 also includes a network interface 173 that enables the printer server 123 to communicate with other devices coupled to the local area network 100 through the network switch. In this respect, the network interface 173 may be, for example, a network interface card or other circuit that includes appropriate buffering circuitry as can be appreciated by those with ordinary skill in the art. The print server 123 includes several software components that are stored in the memory 166 and are executable by the processor 163. The software components include, for example, an operating system 176, the print queue(s) 129, the print tracking system 133, and the port/room table 136.

The memory 166 is defined herein as both volatile and nonvolatile memory and data storage components. Volatile components are those that do not retain data values upon loss of power. Nonvolatile components are those that retain data upon a loss of power. Thus, the memory 166 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 163 may represent multiple processors and the memory 166 may represent multiple memories that operate in parallel. In such a case, the local interface 169 may be an appropriate network that facilitates communication between any two of the multiple processors, between any processor and any one of the memories, or between any two of the memories etc. The processor 163 may be electrical, molecular, or optical in nature.

The operating system 176 is executed to control the allocation and usage of hardware resources in the print server 123 such as the memory, processing time and peripheral devices. In this manner, the operating system 176 serves as the foundation on which applications depend as is generally known by those with ordinary skill in the art.

The print tracking system 133 may be written in any one of a number of programming languages such as, for example, C, Java, C++, C#, Visual Basic, Perl, Python, and any other computer language that may be compiled and interpreted appropriately.

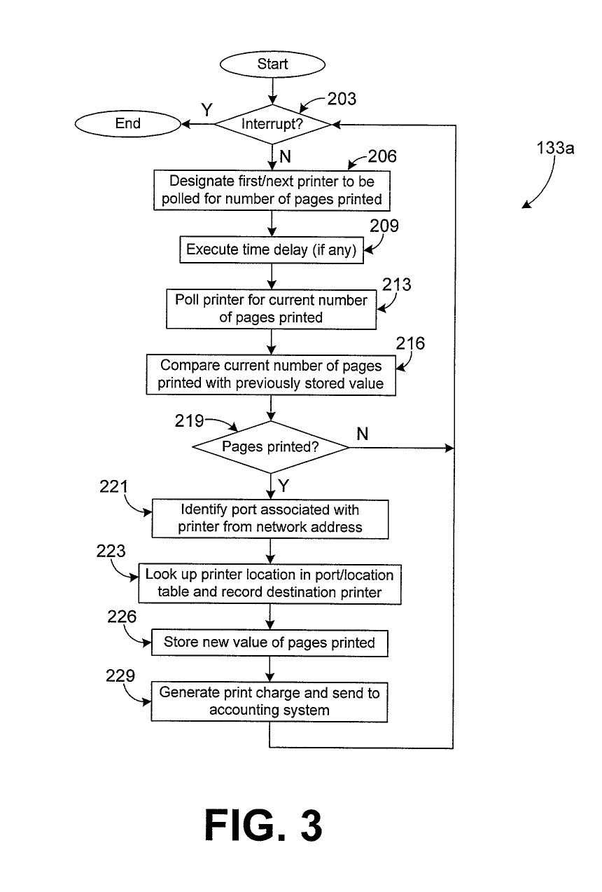

Turning then to FIG. 3, shown is a flow chart of a first embodiment of the print tracking system 133 denoted herein as print tracking system 133a. Alternatively, the flow chart of FIG. 3 may be viewed as depicting steps in a method implemented in the print server 123 to obtain information relative to printing of a document in a respective one of the rooms A, B, or C (FIG. 1) for billing purposes. The print tracking system 133a simply determines the number of pages printed on a respective printer 103 located in a respective one of the rooms A, B, or C. Once such information is known, then charges may be developed for the number of pages printed for the individual that rents the respective room A, B or C as appropriate.

Beginning with box 203, the print tracking system 133a determines whether an interrupt condition exists such that the operation of the print tracking system 133a should end. If such is the case, then the print tracking system 133a ends accordingly. Otherwise, the print tracking system 133a proceeds to box 206.

In box 206, one of the printers 106 coupled to the local area network 100 (FIG. 1) is designated to be polled for the print count 146 maintained in such printer 106. Each time the print tracking system 133a reaches box 206, a different one of the printers 106 may be designated, for example, according to a predetermined order. Thereafter, in box 209, a time delay may be executed if necessary to space out inquiries made to respective ones of the printers 106. Thereafter, in box 213, the print tracking system 133a polls the respective printer 106 for the current page count 146 contained therein. In order to poll one of the printers 106 as such, the print tracking system 133a may generate the print count query 143 (FIG. 1) that is applied to the printer 106. Upon receiving the print count query 143, the respective printer 106 responds by transmitting the print count 146 back to the print tracking system 133a. The respective printer 106 thereafter responds with the print count 146 that is sent back to the print tracking system 133a through the local area network 100.

Then in box 216, the current value for the print count 146 obtained from the printer 106 is compared with a previously obtained value for the print count 146 that was stored in the memory 166 (FIG. 2). Next, in box 219, it is determined whether any pages have been printed on the respective printer 106. This may be determined by subtracting the previously stored value of the print count 146 stored in the memory 166 from the current print count 146 most recently obtained. If the value is a number other than zero, then the print tracking system 133a proceeds to box 223. Otherwise, the print tracking system 133a reverts back to box 203 to start anew since no pages were printed.

Assuming that the print tracking system 133a has proceeded to box 223, then at least one page has been printed on the respective printer 106. In box 221 the print tracking system 133a determines a port 116 (FIG. 1) associated with the printer 106 for which the printing of at least one page was detected. This may be done, for example, by interrogating the network switch 113 (FIG. 1) as to the port that is associated with a network address associated with the printer 106. The print tracking system 133a may interrogate the network switch 113 using any standard or proprietary protocol such as Simple Network Management Protocol (SNMP). As contemplated herein, a network address may be a MAC address, an IP address, or other similar address. Thereafter, in box 223 the location of the printer 106 is identified by mapping the port 116 identified in box 221 to a printer location A, B, or C using the port/room table 136 (FIG. 1). Then in box 226 the most recent value for the print count 146 obtained from the respective printer 106 is stored in the memory 106 in an appropriate table in association with the printer 106 for future comparison with later acquired values of the print count 146 in box 216. Thereafter, in box 226, a print charge is generated by the print tracking system 133a that is sent to the accounting system 139 (FIG. 1). The print charge includes various information such as, for example, a total charge for the pages printed as well as the destination printer location (i.e. room A, B, or C), a charge code, and/or a description of the charge incurred. Thereafter the print tracking system reverts back to box 203 as shown. The accounting system 139 then incorporates the print charge into a bill for the user who rents the respective room A, B or C so that they can be charged for the use of the printer 106. Thereafter, the print tracking system 133a reverts back to box 203.

Thus, the print tracking system 133a continually polls the printers 106 associated with the local area network 100 to determine whether the printers 106 in their respective rooms A, B, or C have printed any pages. The printing of any pages on such printers 106 is detected and a charge is ultimately generated that is applied to the accounting system 139 to generate the charge on a bill.

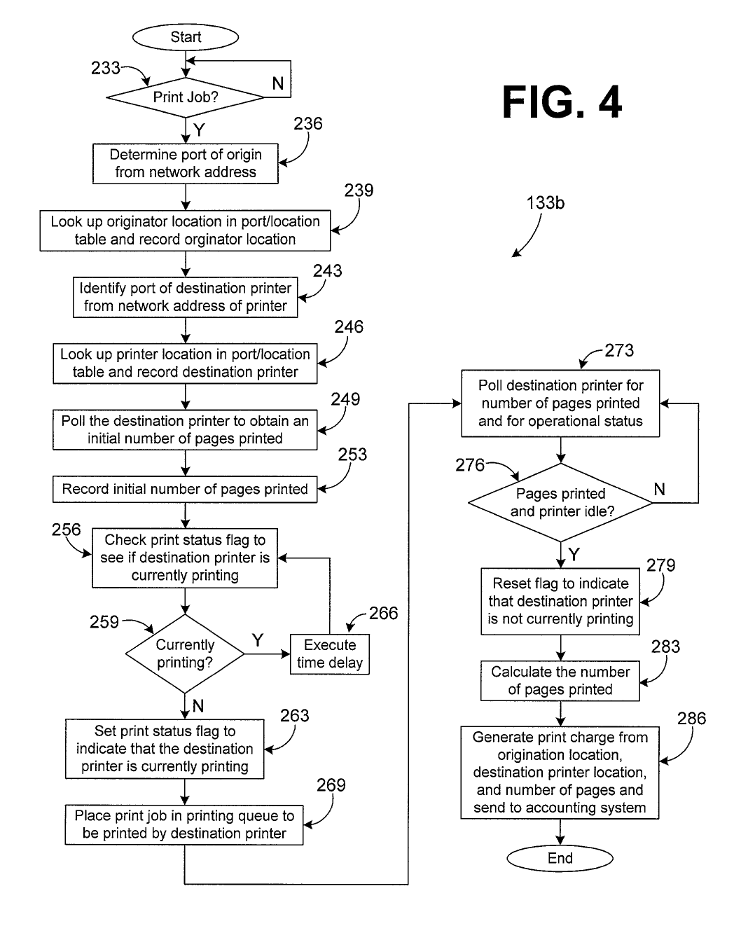

Turning then to FIG. 4, shown is the second embodiment of the print tracking system 133 (FIG. 1) denoted herein as print tracking system 133b. Alternatively, the flow chart of FIG. 4 may be viewed as steps in a method implemented in the print server 123 (FIG. 1) to track printing of a print job on a respective one of the printers 106 (FIG. 1) located in a respective room A, B, or C (FIG. 1) for billing purposes. The print tracking system 133b advantageously provides for the tracking of an origination location of a print job as well as the location of the destination printer 106 upon which the print job is to be printed. In addition, the print tracking system 133b also facilitates determining the number of pages printed for a respective print job and generates a print charge therefrom that is reported to the accounting system 139 (FIG. 1) for billing purposes.

Beginning with box 233, the print tracking system 133b determines whether a print job has been received in the print server 123 from a respective one of the computers 103 (FIG. 1) located in one of rooms A, B, or C. Assuming such to be the case, then the print tracking system 133b proceeds to box 236 in which a port 116 (FIG. 1) that is associated with the respective computer 103 is determined. This may be determined, for example, from a network address from the print job that is associated with the respective computer 103 that originated the print job. Specifically, the print tracking system 133b queries the network switch 113 to identify the respective port 116 that is associated with network address associated with the respective computer 103.

Thereafter, in box 239, the originator location such as, for example, rooms A, B, or C is obtained by mapping the port 116 obtained in box 236 to the respective location or room using the port/room table 136 (FIG. 1). Thereafter, in box 243, the port 116 of the destination printer 106 is identified from the network address of such printer that is included in the print job. This may be done, for example, by interrogating the network switch 113 as to the port associated with the respective network address of the printer 106.

Then in box 246, the destination printer location such as, for example, room A, B, or C is identified by mapping the previously identified port in box 243 to the respective location using the port/room table 136 (FIG. 1). Thereafter, in box 249, the destination printer 106 is polled with a print count query 143 to obtain an initial print count from the printer 106. The printer 106 then responds with a current print count 146 that is transmitted back to the print server 123. Then in box 253, the initial print count obtained from the printer 106 is stored in the memory 166 for future reference.

Thereafter, in box 256, the print tracking system 133b checks a print status flag associated with the respective printer 106 upon which the print job is to be printed. If set, the print status flag indicates that the destination printer 106 is currently printing and cannot receive a new print job. The print status flag may be maintained in the memory 166 (FIG. 2) in accordance with the operation of the print tracking system 133b. In box 259, if the print status flag is not set thereby indicating that the respective printer 106 is available for printing, then the print tracking system 133b proceeds to box 263. Otherwise, the print tracking system 133b proceeds to box 266. Assuming in box 259 that the print status flag was set, thereby indicated that the destination printer 106 is printing, then in box 266 the print tracking system 133b executes a time delay to wait for the destination printer 106 to complete its printing operation. Thereafter, the print tracking system 133b reverts back to box 256 to check the print status flag once again to see if in fact the printing operation has been completed.

On the other hand, assuming that the print tracking system 133b proceeds to box 263, then the print status flag is set to indicate that the destination printer 106 is currently printing. This is done as the current print job to be printed on the destination printer 106 will soon be applied to the printer 106. As such, setting the print status flag prevents other print jobs from being applied to the printer until the print status flag is reset as will be discussed. Thereafter, in box 269, the print job to be sent to the destination printer 106 is placed in the appropriate printing queue 129 (FIG. 1) from which the print job will be sent to the respective printer 106 for printing. Thereafter, in box 273, the print tracking system 133b polls the destination printer for the current print count as well as the operational status of the destination printer 106. The operational status of the printer may be, for example, “printing,” “idle,” or other appropriate status as is generally known by those with those with ordinary skill in the art.

The destination printer 106 is polled for the operational status determine whether the destination printer 106 has completed printing the current print job. Such would be the case if the destination printer 106 was in an “idle” state after having printed the pages in the print job. Thus, assuming that the destination printer begins to print the print job after the print job has been applied to the appropriate printing queue 129, then the operational status of the printer 106 will be “printing” until the print job is complete. Thus, by requesting the operational status of the destination printer 106 in box 273, the print tracking system 133b will determine when the printer 106 has completed printing the print job.

However, if the destination printer 106 is polled in box 273 before transitioning to the “printing” state, then it may be in the idle state. Consequently, the print count obtained at that time will inform the print tracking system 133b whether the destination printer has printed any pages by comparing the print count with the initial print count obtained in box 249.

In addition, assuming that the operational status of the destination printer is “idle” and that at least one page has printed beyond those noted in the print count from box 249, then the page count obtained from the printer 106 in box 273 would be equal to the initial page count obtained in box 253 plus the number of pages printed in the current print job. Thus in box 276, if the printer is idle after having printed at least one page, then the print tracking system 133b proceeds to box 279. Otherwise, the print tracking system 133b reverts back to box 273 to continue to poll the destination printer 106 to determine when it has completed printing the current print job and to obtain a current print count.

Assuming that the printing of the print job is complete, then in box 279, the print status flag is reset to indicate that the destination printer 106 is not currently printing. This makes the destination printer 106 available to print the next print job. Then in box 283, the total number of pages printed for the print job is calculated by subtracting the initial page count obtained from the destination printer in box 253 from the most recently determined page count in box 276. This results in a total number of pages printed by the destination printer 106. Thereafter, in box 286, a print charge is generated by the print tracking system 133b that is sent to the accounting system 139. The print charge includes various information such as, for example, a total charge for the pages printed as well as the origination location, destination printer location (i.e. room A, B, or C), a charge code, and/or a description of the charge incurred. The print charge may be based, for example, upon the origination location, the destination printer location, and the number of pages. In this respect, the print tracking system 133b provides the necessary information to the accounting system 139 that facilitates creating a billable line item for each print job.

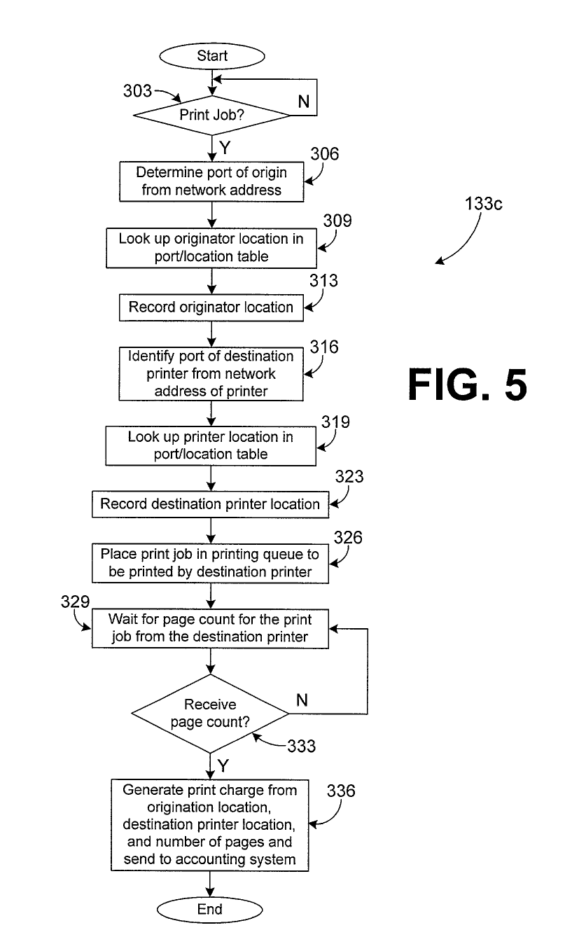

With reference next to FIG. 5 shown is a flow chart of another embodiment of the print tracking system 133 denoted herein as print tracking system 133c. Alternatively, the flow chart of FIG. 5 may be viewed as depicting steps of a method implemented in the print server 123 (FIG. 1) to track the location of the origination location and location of the destination printer used to print a print job as well as the number of pages in the print job to generate a print charge therefrom that is applied to the accounting system 139 (FIG. 1) for billing purposes.

In this respect, the print tracking system 133c begins with box 303 in which it is determined whether a print job has been received from one of the computers 103 destined from one of the printers 106. If such is the case, then the print tracking system 133c proceeds to box 306 in which a port 116 (FIG. 1) of the network switch 113 (FIG. 1) that is coupled to the computer 103 that originated the print job is determined. The port 116 is determined by identifying the network address associated with the computer 103 that generated the print job. This network address may be found within the print job or in the protocol used to submit the print job. The port 116 is determined by interrogating the network switch 113 for the port 116 associated with the network address. Thereafter, in box 309 the originator location such as the room A, B, or C (FIG. 1) in which the computer 103 is located is determined. This may be done by mapping the port 116 identified in box 306 with the room A, B, or C using the port/room table 136 (FIG. 1). Thus, a static relationship between the ports 116 and the rooms A, B, or C are assumed due to the fact that each of the ports 116 is connected to respective jack in one of rooms A, B, and C.

Next, in box 313, the originator location (i.e. room A, B, or C, etc.) is recorded in the memory 166 for future reference. Thereafter, in box 316, a port 116 that is associated with the destination printer 106 is identified using the network address of the destination printer 106. Specifically, the print tracking system 133c interrogates the network switch 113 to obtain the port 116 associated with the network address of the destination printer 106. The network address may be obtained from the print job itself or from the protocol used to submit the print job. Thereafter, in box 319, the destination printer location (i.e. room A, B or C) is obtained based upon the port 116 obtained in box 316 by mapping the port 116 to the printer destination location using the port/room table 136 (FIG. 1). Thereafter, in box 323, the destination printer location is recorded in the memory 166 for future reference.

Then in box 326, the print job is placed in an appropriate print queue 129 associated with the destination printer 106. The print queue 129 automatically proceeds to feed the print job to the destination printer 106 for printing. Thereafter, in box 329, the print tracking system 133c waits for a number of pages printed in the print job to be received from the destination printer 106. In this respect, the print counter 109 within the destination printer 106 tracks the number of pages printed for a particular print job and then automatically transmits the resulting number of pages printed to the print tracking system 133c. The printer 106 can get the network address of the print server 123 to transmit the number of pages printed from the print job itself or from the protocol used to submit the print job. In box 333, if the print tracking system 133c receives the number of pages of the print job from the destination printer 106, then the print tracking system 133c proceeds to box 336. Otherwise, the print tracking system 133c reverts back to box 329.

In box 336, a print charge is generated by the print tracking system 133c that is sent to the accounting system 139. The print charge includes various information such as, for example, a total charge for the pages printed as well as the origination location, destination printer location (i.e. room A, B, or C), a charge code, and/or a description of the charge incurred. The print charge may be based, for example, upon the origination location, the destination printer location, and the number of pages in the print job. In this respect, the print tracking system 133c provides the necessary information to the accounting system 139 that facilitates creating a billable line item for each print job.

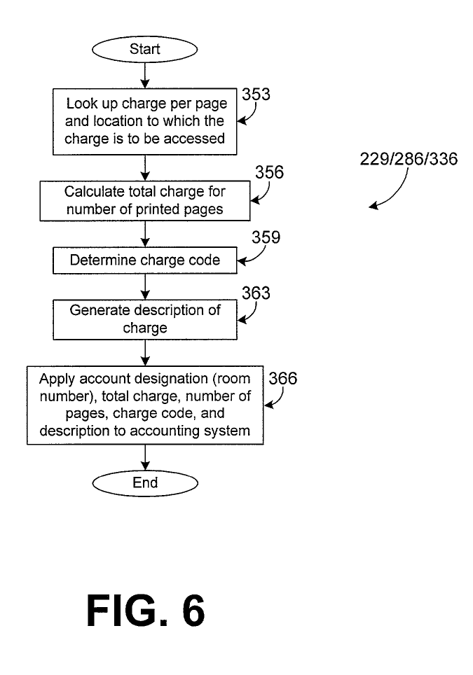

Turning then to FIG. 6, shown is a flow chart that provides an example of further functionality of the print tracking systems 133a (FIG. 3), 133b (FIG. 4), or 133c (FIG. 5) as described in boxes 229 (FIG. 3), 286 (FIG. 4), or 336 (FIG. 5). Alternatively, the flow chart of FIG. 6 may be viewed as depicting steps in a method implemented in the print tracking systems 133a, 133b, or 133c, respectively, to determine a print charge that is applied to the accounting system 139.

Beginning with box 353, first the charge per page is looked up in a print charge table stored in the memory 166 (FIG. 2). In the case of the print tracking system 133a, the print charge table may provide a charge based, for example, upon the destination printer location since this is the only information known. Thus, the room number for billing purposes is the destination printer location.

In the case of the print tracking systems 133b and 133c, in one embodiment the print charge table may include, for example, several printer scenarios that lists print charges and the respective rooms A, B, or C to which charges are accessed in association with the origination location and/or destination printer location. In this embodiment, the print table lists a number of different print scenarios for determining the charge to be incurred for a printing service and to determine what room A, B, or C to which the charge is to be accessed. The charges may vary from printer to printer or based upon the specific print scenario since the charges per page are associated with specific print scenarios. An example of such a table is provided below:

| Origination | Destination | Charge per | Access |
|---|---|---|---|
| Location | Printer Loc | Page | Charge to |
| Room A | Room A | .05 | Room A |
| Lobby | Room A | .05 | Room A |
| Room A | Lobby | .10 | Room A |

In the above table, if a customer prints from their Room A to the printer 106 in Room A, then the charge is to be accessed to Room A. Alternatively, if a customer prints from a network port in the lobby or other public area to the printer in Room A, then the charges are also accessed to Room A. In still another alternative, if a customer prints from their Room A to a centralized printer in the lobby (perhaps an enhanced color printer with greater features than the printer in Room A), then Room A is also accessed with the print charges. Note that the above table provides for flexibility in accessing different charges for the various printing scenarios.

Once the print charge per page and the room or location to which the print charge is to be accessed are known, then in box 356 the total charge is calculated for all printed pages by multiplying the charge per page by the number of pages printed. Next, in box 359 a charge code is obtained that indicates, for example, a print charge. Thereafter, in box 363 a description of the charge is generated. The description may be generated by looking up appropriate language saved in memory and adding appropriate values. For example, the description may be “Print charge for Room 7” with a quantity indication for the number of pages printed, etc. Then in box 366 the room A, B, or C to which the charges are to be accessed, the total charge, number of pages printed, charge code, and description are provided to the accounting system 139 to be posted to a bill for the specified room A, B, or C.

Although in various embodiments, the print tracking system 133 is described as being implemented in terms of software or code executed by general purpose hardware as discussed above, as an alternative the print tracking system 133 may also be embodied in dedicated hardware or a combination of software/general purpose hardware and dedicated hardware. If embodied in dedicated hardware, the print tracking system 133 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

Also, the flow charts of FIGS. 3-5 show the architecture, functionality, and operation of an implementation of the print tracking system 133. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the print tracking system 133 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the print tracking system 133 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

What is claimed is:

1. A print tracking method for accounting purposes, comprising:
periodically polling a number of printers to obtain a printed page count from each of the number of printers;
determining a number of pages printed by each of the printers between a previously acquired printed page count and a newly acquired page count for each of the printers; and
associating the number of pages printed by at least one of the printers with an account designation.

2. The method of claim 1, further comprising reporting the number of pages printed by the at least one of the printers and the account designation associated therewith to an accounting system to be included in a bill.

3. The method of claim 1, wherein the associating of the number of pages printed by the at least one of the printers with the account designation further comprises mapping the at least one of the printers to the account designation.

4. A program embodied in a computer readable medium for tracking printing on a number of printers for accounting purposes, comprising:
code that periodically polls the number of printers to obtain a printed page count from each of the number of printers;
code that determines a number of pages printed by each of the printers between a previously acquired printed page count and a newly acquired page count for each of the printers; and
code that associates the number of pages printed by at least one of the printers with an account designation.

5. The program embodied in a computer readable medium of claim 4, further comprising code that reports the number of pages printed by the at least one of the printers and the account designation associated therewith to an accounting system to be included in a bill.

6. The program embodied in a computer readable medium of claim 4, wherein the code that associates the number of pages printed by the at least one of the printers with the account designation further comprises a table maps the at least one of the printers to the account designation.

7. A system for tracking printing on a number of printers for accounting purposes, comprising:
a processor circuit having a processor and a memory;
a print tracking system stored in the memory and executable by the processor, the print tracking system comprising:
logic that periodically polls the number of printers to obtain a printed page count from each of the number of printers;
logic that determines a number of pages printed by each of the printers between a previously acquired printed page count and a newly acquired page count for each of the printers; and
logic that associates the number of pages printed by at least one of the printers with an account designation.

8. The system of claim 7, wherein the print tracking system further comprises logic that reports the number of pages printed by the at least one of the printers and the account designation associated therewith to an accounting system to be included in a bill.

9. The system of claim 7, wherein the logic that associates the number of pages printed by the at least one of the printers with the account designation further comprises a table that maps the at least one of the printers to the account designation.

10. A system for tracking printing on a number of printers for accounting purposes, comprising:
means for periodically polling the number of printers to obtain a printed page count from each of the number of printers;
means for determining a number of pages printed by each of the printers between a previously acquired printed page count and a newly acquired page count for each of the printers; and
means for associating the number of pages printed by at least one of the printers with an account designation.

11. The system of claim 10, further comprising means for reporting the number of pages printed by the at least one of the printers and the account designation associated therewith to an accounting system to be included in a bill.

12. The system of claim 10, wherein the means for associating the number of pages printed by the at least one of the printers with the account designation further comprises a table that maps the at least one of the printers to the account designation.

13. A method for tracking printing on a number of printers for accounting purposes, comprising:
determining an origination location of a print job;
determining a destination printer location associated with the print job;
determining a number of printed pages associated with the print job;
determining a print charge to be accessed for printing the print job; and
determining a location to which the print charge is to be accessed.

14. The method of claim 13, further comprising applying the location and the print charge to an accounting system to generate a bill entry therefrom.

15. The method of claim 13, wherein the determining of the number of printed pages associated with the print job further comprises receiving a message from a destination printer that includes the number of printed pages.

16. The method of claim 13, wherein the determining of the number of printed pages associated with the print job further comprises:
polling a destination printer for a first page count before printing the print job;
polling the destination printer for a second page count after printing the print job; and
subtracting the first page count from the second page count, thereby obtaining the total number of printed pages.

17. The method of claim 13, wherein the determining of the origination location of the print job further comprises:
identifying a port of a network switch associated with a network address of an originating device identified in the print job; and
mapping the port to the origination location.

18. The method of claim 17, wherein the mapping of the port to the origination location further comprises mapping the port to a room designation that is associated with one of a number of rooms, wherein the origination location is the one of the number rooms.

19. The method of claim 13, wherein the determining of the destination printer associated with the print job further comprises:
identifying a port of a network switch associated with a network address of a destination printer identified in the print job; and
mapping the port to the destination printer location.

20. The method of claim 191 wherein the mapping of the port to the destination printer location further comprises mapping the port to a room designation of a room in which the destination printer is located, wherein the destination printer location is the room in which the destination printer is located.

21. A program embodied in a computer readable medium for tracking printing on a number of printers for accounting purposes, comprising:
code that determines an origination location of a print job;
code that determines a destination printer location associated with the print job;
code that determines a number of printed pages associated with the print job;
code that determines a print charge to be accessed for printing the print job; and
code that determines a location to which the print charge is to be accessed from at least one of the origination location and the destination printer location.

22. The program embodied in a computer readable medium of claim 21, further comprising code that applies the location and the print charge to an accounting system to generate a bill entry therefrom.

23. The program embodied in a computer readable medium of claim 21, wherein the code that determines the number of printed pages associated with the print job further comprises code that obtains the number of printed pages from a message received from a destination printer that includes the number of printed pages.

24. The program embodied in a computer readable medium of claim 21, wherein the code that determines the number of printed pages associated with the print job further comprises:
code that polls a destination printer for a first page count before printing the print job;
code that polls the destination printer for a second page count after printing the print job; and
code that subtracts the first page count from the second page count, thereby obtaining the total number of printed pages.

25. The program embodied in a computer readable medium of claim 21, wherein the code that determines the origination location of the print job further comprises:
code that identifies a port of a network switch associated with a network address of an originating device identified in the print job; and
code that maps the port to the origination location.

26. The program embodied in a computer readable medium of claim 25, wherein the code that maps of the port to the origination location further comprises code that maps the port to a room designation that is associated with one of a number of rooms, wherein the origination location is the one of the number rooms.

27. The program embodied in a computer readable medium of claim 21, wherein the code that determines the destination printer associated with the print job further comprises:
code that identifies a port of a network switch associated with a network address of a destination printer identified in the print job; and
code that maps the port to the destination printer location.

28. The program embodied in a computer readable medium of claim 27, wherein the code that maps the port to the destination printer location further comprises code that maps the port to a room designation of a room in which the destination printer is located, wherein the destination printer location is the room in which the destination printer is located.

29. A system for tracking printing on a number of printers for accounting purposes, comprising:
a processor circuit having a processor and a memory;
a print tracking system stored in the memory and executable by the processor, the print tracking system comprising:
logic that determines an origination location of a print job;
logic that determines a destination printer location associated with the print job;
logic that determines a number of printed pages associated with the print job;
logic that determines a print charge to be accessed for printing the print job; and
logic that determines a location to which the print charge is to be accessed from at least one of the origination location and the destination printer location.

30. The system of claim 29, further comprising logic that applies the location and the print charge to an accounting system to generate a bill entry therefrom.

31. The system of claim 29, wherein the logic that determines the number of printed pages associated with the print job further comprises logic that obtains the number of printed pages from a message received from a destination printer that includes the number of printed pages.

32. The system of claim 29, wherein the logic that determines the number of printed pages associated with the print job further comprises:
logic that polls a destination printer for a first page count before printing the print job;
logic that polls the destination printer for a second page count after printing the print job; and
logic that subtracts the first page count from the second page count, thereby obtaining the total number of printed pages.

33. The system of claim 29, wherein the logic that determines the origination location of the print job further comprises:
logic that identifies a port of a network switch associated with a network address of an originating device identified in the print job; and
logic that maps the port to the origination location.

34. The system of claim 29, wherein the logic that determines the destination printer associated with the print job further comprises:
logic that identifies a port of a network switch associated with a network address of a destination printer identified in the print job; and
logic that maps the port to the destination printer location.

35. A system for tracking printing on a number of printers for accounting purposes, comprising:
means for determining an origination location of a print job;
means for determining a destination printer location associated with the print job;
means for determining a number of printed pages associated with the print job; and
means for determining a print charge to be accessed for printing the print job; and
means for determining a location to which the print charge is to be accessed from at least one of the origination location and the destination printer location.

36. The system of claim 35, wherein the means for determining the number of printed pages associated with the print job further comprises means for obtaining the number of printed pages from a message received from a destination printer that includes the number of printed pages.

37. The system of claim 35, wherein the means for determining the number of printed pages associated with the print job further comprises:
means for polling a destination printer for a first page count before printing the print job;
means for polling the destination printer for a second page count after printing the print job; and
means for subtracting the first page count from the second page count, thereby obtaining the total number of printed pages.

38. The system of claim 35, wherein the means for determining the origination location of the print job further comprises:
means for identifying a port of a network switch associated with a network address of an originating device identified in the print job; and
a table that maps the port to the origination location.

39. The system of claim 35, wherein the means for determining the destination printer associated with the print job further comprises:
means for identifying a port of a network switch associated with a network address of a destination printer identified in the print job; and
a table that maps the port to the destination printer location.
